(19) United States
(12) Patent Application Publication
(10) Pub. No.: US 2020/0043029 A1
(43) Pub. Date: Feb. 6, 2020

(54) SYSTEMS AND METHODS FOR COMPUTER-IMPLEMENTED OPTIMIZED PRICING UNDER DIFFUSION-CHOICE MODELS

(71) Applicant: Hongmin Li, Tempe, AZ (US)

(72) Inventor: Hongmin Li, Tempe, AZ (US)

(73) Assignee: Arizona Board of Regents on Behalf of Arizona State University, Temep, AZ (US)

(21) Appl. No.: 16/530,372

(22) Filed: Aug. 2, 2019

Related U.S. Application Data
(60) Provisional application No. 62/713,759, filed on Aug. 2, 2018.

(51) Int. Cl. G06Q 30/02; G06Q 10/06

(52) U.S. Cl. CPC G06Q 30/0206; G06Q 10/067; G06Q 30/0202

(57) ABSTRACT

Embodiments for systems and methods for optical pricing under diffusion-choice models, i.e., models combining consumer choice with diffusion, are disclosed.

### CROSS REFERENCE TO RELATED APPLICATIONS

This is a U.S. non-provisional patent application that claims benefit to U.S. provisional patent application Ser. No. 62/713,759 filed on Aug. 2, 2018, which is incorporated by reference in its entirety.

### FIELD

The present disclosure generally relates to systems and methods for price optimization; and in particular relates to a computer-implemented method for optimal pricing of multi-product diffusion under diffusion-choice models, i.e., models that combine consumer choice with product diffusions.

### BACKGROUND

Product adoption often resembles a diffusion process and the resulting sales exhibit a time trend that can be described by a diffusion equation and characterized by a bell-shaped curve. When the diffusion of a product takes place in parallel with substitute products offered by the same firm, demand interactions among the products create interesting and challenging complications for decision makers. For example, sales of a new book exhibit diffusion characteristics, and often hardcover, paperback, and electronic versions of the same book are sold concurrently. It is also common for manufacturers of technology products to introduce multiple variations of a new product to the market, each variation as a separate model, diffusing into the market concurrently. For example, Apple introduces three different versions of iPhone7 (32 GB, 128 GB, and 256 GB memory), as well as three different versions of iPhone7plus concurrently. Product prices and the resulting price differences among the products play an important role in shaping the diffusion of the products and customers' product choice.

In practice, firms adopt varied pricing strategies. Prices of microprocessors go through periodic downward readjustment as the products enter different phases of their life cycles. By the end of a two-year life cycle, the retail prices of smart phones are reduced by 34% on average. Prices of Apple's iPhone slid by 25% between 22 and 28 months of age and the retail price of Apple's iPhone 5s declined by 7% one year after launch. Samsung uses an interesting strategy in which the average retail price peaks one month after release with the introduction price at a 10% discount of the peak price and the ending price at 50% discount. Price increase is observed also in other product categories. A previous study indicates that the introduction prices for new beer varieties are relatively cheap and prices are raised once a following is established. Amazon routinely adjusts prices for books with strong life cycle characteristics such as those in the “Mystery, Thriller and Suspense” category, where both price decreases and price increases are observed in the first few weeks of release. These anecdotal albeit prevalent phenomena suggest diverse pricing strategies for products through their life cycles.

The difficulty and complexity of pricing decisions in diffusion often drive firms to myopic strategies. According to PriceBeam, a pricing solution provider, companies sometimes conduct extensive research on setting the proper launch price but fails to re-evaluate the pricing continuously over the product life cycle (PLC): “This is problematic in two ways: Firstly, you will either be losing out on revenue or leaving money on the table as you fail to take into account the changes in the customer's willingness-to-pay, and secondly, it will most likely deteriorate the returns on other products in your portfolio. Proper life cycle pricing across both the early, mid- and late-stage of the PLC is absolutely crucial to reap the rewards from the R&D investment.”

It is with these observations in mind, among others, that various aspects of the present disclosure were conceived and developed.

### BRIEF DESCRIPTION OF THE DRAWINGS

FIG. 1 is a simplified block diagram illustrating the concept of choice decision in product diffusion;

FIG. 2A is a graphical representation showing the effect of β with α fixed at 0.04 and FIG. 2B is a graphical representation showing the effect of α with β fixed at 0.4;

FIGS. 3A-3C are graphical representations showing optimal prices vs. parameters α and β;

FIGS. 4A-4C are a graphical representations showing the effect of increasing price sensitivity;

FIGS. 5A-5C are graphical representation showing the effect of declining cost;

FIGS. 6A-8C are graphical representations illustrating an example of Corollary 5;

FIGS. 7A-7C are graphical representation illustrating the impact of product variety breadth;

FIGS. 8A-8C are graphical representation illustrating the impact of variety depth on sales;

FIGS. 9A-9C are graphical representation illustrating the impact of product variety depth;

FIGS. 10A and 10B are graphical representation showing heuristic price solution;

FIG. 11 is an example schematic diagram of a computing system that may implement various methodologies of the system and method for optical pricing under diffusion-choice models; and

FIG. 12 is a simplified block diagram illustrating an exemplary network/system embodiment for a computer-implemented method of adjusting parameters related to pricing over a products' life cycle when demand exhibits diffusion characteristics and customers choose among multiple available product options as described herein.

Corresponding reference characters indicate corresponding elements among the view of the drawings. The headings used in the figures do not limit the scope of the claims.

### DETAILED DESCRIPTION

### Introduction

A technical solution is needed that continuously optimizes product prices and accounts for product interactions throughout the diffusion, yet, pricing in multi-product diffusion is under-studied in the academic literature and existing models are complicated and intractable. Existing pricing models for product diffusion either only work for a single product or are too stylized to provide decision support. Aspects of the present disclosure relate to a technical solution in the form of a computer-implemented model and methods thereof configured for price optimization that applies to both simultaneous and sequential product introductions and adapts to stochastic demand.

The general diffusion model has been successful in modeling product adoption and the resulting aggregate demand pattern, and has been extended to include marketing-mix variables such as advertising and pricing. However, it does not extend easily to admit product and consumer characteristics data for sales prediction. On the contrary, choice models (in particular, logit choice models) have been very successful in linking consumer and product attributes to sales prediction, however, they do not address the diffusion dynamics that are inherent to the demand of a product over its life cycle. Therefore, as set forth herein, the combination of choice models with diffusion makes it possible to incorporate customer demographics, price, and product attributes and to utilize cross-sectional data on customers' purchasing decision to predict sales penetration in product diffusions. In the present disclosure, a pricing model is utilized that combines customer choice with diffusion, and overcome technical hurdles to develop a scalable solution algorithm.

In particular, the present disclosure relates to a technical solution in the form of a computer-implemented method of adjusting parameters related to pricing over a products' life cycle when demand exhibits diffusion characteristics and customers choose among multiple available product options. It is believed that the present disclosure is the first to express the pricing problem in diffusion-choice models. From a theoretical perspective, the present disclosure discusses both the pricing and revenue management literature and the diffusion theory literature. It is believed that no prior work examines pricing under diffusion-choice models despite their proven merits. Solving the optimal pricing problem under diffusion choice models makes significant technical and practical contributions. A key advantage of the pricing model disclosed herein is its tractability for multi-product diffusion and, unlike existing pricing models for diffusion, the complexity and computation burden grow very little with the number of products. In the pricing and revenue management literature, multinomial logit (MNL) and related choice models are well studied but none from within the context of product diffusion.

The problem becomes significantly harder when examined with diffusion, as customer choices in the current period affect future sales. As a result of this dependency, the state-of-art solution approach does not apply. The present disclosure presents an analysis that circumvents this complexity and show that the optimal solution is unique and efficiently obtainable. Moreover, properties of the optimal solution are characterized, thereby yielding insights into this complex pricing problem.

The present disclosure acknowledges two key forces driving product adoption—innovative and imitative behaviors of the consumers. Innovators are early adopters whose decision is not influenced by previous adopters whereas imitators learn from others and feel increasing pressure for adoption as the number of adoptions increases. The imitation effect is also referred to as the word-of-mouth effect. The magnitude of this effect varies by industry as shown in previous studies. A series of Bass model extensions incorporate the price variable by modifying the total market potential or the adoption rate with a price term; previous works show that the optimal price trend depends on the word-of-mouth effect and that penetration pricing (skim pricing) is optimal with strong (weak) word-of-mouth effect. Another known work characterizes the optimal price trajectory under a variation of the generalized Bass model and show that the transition point of price trend depends on the discount factor and the price sensitivity parameter instead of the innovation and imitation parameters; with zero discounting, the optimal price shows a monotonically increasing trend nearly for the entire planning horizon. In the present disclosure, a unimodal price path is established for time-invariant product quality, price sensitivity and cost, generalizing the result in previous works to multi-product diffusion. In addition, the present model allows more general price trend to be justified by the effect of time-variant product attributes, price sensitivity, and cost.

The present model is flexible, capturing not only intertemporal changes in price sensitivity, but also its effect on diffusion and future sales. Most pricing models are for a single product and those that do address more than one product are typically in a stylized setting with only two products. These models become cumbersome and intractable for price optimization as the number of products increases beyond two. In contrast, the present disclosure considers pricing in a multi-product diffusion with adoption decisions given by the MNL choice model and provides a scalable algorithm to solve the problem for n products over T periods, which was unattainable with previous models. Consumer utility is a function of both product quality and price and each consumer chooses the product that maximizes his/her own utility. As a result, the present disclosure is able to capture the effect not only of diffusion dynamics, but also of product attributes and the demand interactions among products. For example, the present disclosure shows that products with higher net quality have larger swings in sales, i.e., larger gap between peak and non-peak sales, a characteristic that prior models were not able to identify. The present disclosure considers diffusion-choice models that explicitly model the diffusion dynamics and characterizes the optimal price behaviors throughout the diffusion cycle.

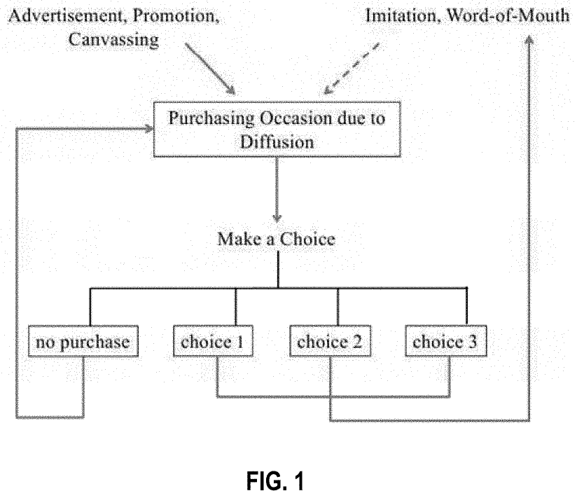

FIG. 1 illustrates consumer choices in a multi-product diffusion, generalizing a single-product adoption model. The present disclosure assumes that the market starts with a certain potential pool of customers. The occurrence of a sale for a particular product i results from two sequential events: first, a purchase occasion arises for a potential customer second, the customer chooses product i among the set of available options (including the no-purchase option). The present disclosure assumes that each customer purchases a single unit. The rate at which purchase occasions arise is driven by two forces: (i) the innovation effect which may depend on the firm's efforts in advertising and promotion, but not on the current adoption level; and (ii) the imitation effect which depends on how many customers have already made a purchase. Once a customer decides to make a purchase, he/she drops out of the potential customer population and enters the adopter population which influences future sales through the imitation effect; if a customer decides not to purchase anything, he/she stays in the potential customer population and may become a future adopter.

The conceptual model and assumptions are similar to the single product adoption model, with the binary logit choices extended to multinomial logit choices and the addition of word-of-mouth (i.e., the dashed arrow connection in FIG. 1). The single product adoption model, along with other existing models have been tested and applied empirically in the marketing and economics literature with proven validity and merits, but none have been studied in a normative prescriptive decision context. The present disclosure adopts a conceptual model and assumptions to study the pricing decision in a multi-product diffusion. Given the empirical practicality and scalability of the model, it offers greater advantage than other multi-product diffusion models that are either too stylized for practical decision support or too complex to be tractable and scalable.

Consider a firm selling n products concurrently and maximizing profit within a given planning horizon of T time periods. Define M as the total market potential. Let Zᵢₜ be the sales of product i in period t and Yₜ be the cumulative sales (including all products) by the end of period t. Thus

$${Y}_{t} = {\sum }_{s = 1}^{t} {\sum }_{i = 1}^{n} {Z}_{is} . \qquad ( 1 )$$

Let the utility of acquiring product i in period t at price pᵢₜ be given by aᵢₜ−bᵢₜpᵢₜ+€ᵢₜ, where aᵢₜ stands for the quality of the product at period t, bᵢₜ is the time-dependent price sensitivity, and €ᵢₜ is a random noise term that is of Gumbel distribution. Here, quality is a measure of attractiveness of the product based on its non-price attributes and features. In addition, the utility of no purchase in each period is normalized to zero.

The present disclosure considers both the innovation and imitation dynamics in product adoption. In particular, the number of customers facing a purchase decision in period t depends on the size of the remaining market potential, (M−Yₜ₋₁), and on a fractional rate (α+β Yₜ₋₁) which is interpreted as the fraction of customers in the remaining market potential who will face a purchase occasion. The linear dependency on the size of adopter population is a basic assumption in Bass and nearly all its extensions. As in Bass, it is assumed that the time unit is chosen such that (α+βYₜ₋₁)∈[0, 1] for Yₜ₋₁∈[0, M], t=1, 2, . . . , T, with α>0 signifying the intensity of the innovation effect and β>0 the intensity of the imitation effect (α denotes the portion of customers whose interest is not affected by the current number of adopters, and βYₜ₋₁ denotes the portion of customers whose interest is influenced by those who have already made a purchase, i.e., the two terms represent the innovators and the imitators respectively). Therefore, the demand for product i in period t is given by

$$\begin{matrix}{Z}_{it} = ( M - {Y}_{t - 1} ) ( α + β {Y}_{t - 1} ) {q}_{it} , i = 1 , … , n & ( 2 ) \\ where {q}_{it} = \frac{exp ( {a}_{it} - {b}_{t} {p}_{it} )}{1 + {\sum }_{j = 1}^{n} exp ( {a}_{jt} - {b}_{t} {p}_{jt} )} & ( 3 )\end{matrix}$$

is the purchase probability given by the MNL choice model. It is denoted the no-purchase probability in period t with

$${q}_{0 t} = \frac{1}{1 + {\sum }_{j = 1}^{n} exp ( {a}_{jt} - {b}_{t} {p}_{jt} )} .$$

In some embodiments, the present disclosure considers the expected demand only and optimizes the firm's profit based on the expected demand given in (2) and assumes an ample supply, both of which are simplifications commonly adopted in the diffusion pricing literature. What follows is an examination of a dynamic pricing problem based on stochastic adoption in an extension.

The firm's price optimization problem is given by

$${max}_{{{p}_{it} ,}_{{i = 1 , … , n ,}_{t = 1 , … , T}}} {\sum }_{t = 1}^{T} {\sum }_{i = 1}^{n} ( {p}_{it} - {c}_{it} ) {Z}_{it}$$

where cᵢₜ is the cost of product i in period t.
From equations (1) and (2), the present disclosure can derive:

$$\begin{matrix}M - {Y}_{t} = ( M - {Y}_{t - 1} ) [ 1 - ( α + β {Y}_{t - 1} ) {\sum }_{i = 1}^{n} {q}_{it} ] , & ( 4 ) \\ α + β {Y}_{t} = ( α + β {Y}_{t - 1} ) [ 1 + β ( M - {Y}_{t - 1} ) {\sum }_{i = 1}^{n} {q}_{it} ] . & ( 5 )\end{matrix}$$

Define Hₜ:=M−Yₜ₋₁ and Fₜ:=α+βYₜ₋₁ for t=1, . . . , T. Then

$$\begin{matrix}{H}_{t} = {H}_{t - 1} ( 1 - {F}_{t - 1} {\sum }_{i = 1}^{n} {q}_{i , t - 1} ) , & ( 6 ) \\ {F}_{t} = {F}_{t - 1} ( 1 + β {H}_{t - 1} {\sum }_{i = 1}^{n} {q}_{i , t - 1} ) , & ( 7 )\end{matrix}$$

and sales of product i in period t can be rewritten as

Zᵢₜ=FₜHₜqᵢₜ. (8)

We observe in equations (3)-(8) that more attractive products obtain higher qᵢₜ values and contribute more to the word-of-mouth effect; for the same reason, they also benefit more from the word-of-mouth effect than the less attractive products.

Note that Hₜ=M−Yₜ₋₁ represents the remaining market potential, and Fₜ=α+βYₜ₋₁ represents the fraction of customers in the remaining market potential that will face a purchase occasion; so the present disclosure refers to Fₜ as the diffusion intensity. The present disclosure can then interpret FₜHₜ as the number of customers facing a purchase decision at time t. The recursions in equations (6) and (7) indicate how the market potential and diffusion intensity evolve over time. The market potential monotonically decreases each period, which is reflected in the multiplicative term (1−Fₜ₋₁ Σᵢ₌₁ⁿ qᵢₜ₋₁), where Fₜ₋₁ Σᵢ₌₁ⁿ qᵢₜ₋₁ signifies the proportion of customers who have made a purchase in period t−1. Since (1−Fₜ₋₁ Σᵢ₌₁ⁿ qᵢₜ₋₁)∈[0,1], the present disclosure refers to it as the shrinkage factor of the market potential from period t−1 to t. Similarly, the diffusion intensity Fₜ monotonically increases each period due to the imitation effect, as reflected by the term (1+βHₜ₋₁ Σᵢ₌₁ⁿ qᵢₜ₋₁); this term is greater than 1 and the present disclosure refers to it as the amplification factor of the diffusion intensity.

The original single-product Bass diffusion model is fully parameterized with α and β, and sales reach peak volume when the multiplicative product of the remaining market potential Hₜ and the diffusion intensity Fₜ reaches its maximum. In the diffusion-choice model, however, sales of each product are also affected by quality aᵢₜ and prices pᵢₜ of all products through the MNL model, and such dependencies are then carried through to future periods through Hₜ and Fₜ values. These dynamics may shift the sales of each product differently. Therefore, the price of each product at any given time has complex rippling effect on the diffusion of this and other products.

### Optimal Pricing Solution

Let πᵢₜ be the profit of product i in period t and define the profit-to-go, Jₜ, as

$${J}_{t} = {max}_{{{p}_{is} ,}_{{i = 1 , … , n ,}_{t = 1 , … , T}}} {\sum }_{s = t}^{T} {\sum }_{i = 1}^{n} {π}_{is} . \qquad ( 9 )$$

From equation (8),

$${π}_{it} = ( {p}_{it} - {c}_{it} ) {Z}_{it} = {F}_{t} {H}_{t} ( {p}_{it} - {c}_{it} ) {q}_{it} and$$

$${J}_{t} = {max}_{{{p}_{is} ,}_{{i = 1 , … , n ;}_{s = t , … , T}}} {\sum }_{s = t}^{T} {\sum }_{i = 1}^{n} {F}_{s} {H}_{s} ( {p}_{is} - {c}_{is} ) {q}_{is} .$$

Rewrite the price pt as a function of the purchase probability vector: qₜ=(q₁ₜ, q₂ₜ, . . . , qₙₜ)

$${p}_{it} ( {q}_{t} ) = \frac{1}{{b}_{t}} ( {a}_{it} - log {q}_{it} + log {q}_{0 t} ) \qquad ( 10 )$$

Where q₀ₜ=1−Σᵢ₌₁ⁿ qᵢₜ. Subsequently,

$${J}_{t} = {max}_{{{q}_{it} ∈ [ 0 , 1 ] ,}_{i = 1 , … , n}} [ {F}_{t} {H}_{t} {\sum }_{i = 1}^{n} ( {p}_{it} ( {q}_{t} ) - {c}_{it} ) {q}_{it} + {J}_{t + 1} ] , \qquad ( 11 )$$

where q₀ₜ=1−Σᵢ₌₁ⁿ qᵢₜ. The first term on the right side of equation (11) is the current-period profit and the second term is the profit-to-go from the next period onward.

$$\begin{matrix} Define {G}_{T + 1} := 0 and \\ & ( 12 \\ {G}_{t} ( {H}_{t} , {F}_{t} , {q}_{t} ) := {\sum }_{i = 1}^{n} ( {p}_{it} ( {q}_{t} ) - {c}_{it} ) {q}_{it} + ( 1 - {F}_{t} {\sum }_{i = 1}^{n} {q}_{it} ) ( 1 + β {H}_{t} {\sum }_{i = 1}^{n} {q}_{it} ) {G}_{t + 1}^{*} ( {H}_{t + 1} , {F}_{t + 1} ) for t \leq T & \\ where & \\ {G}_{t}^{*} ( {H}_{t} , {F}_{t} ) = {max}_{{q}_{t}} {G}_{t} ( {H}_{t} , {F}_{t} , {q}_{t} ) . & ( 13 )\end{matrix}$$

Note that both Hₜ₊₁ and Fₜ₊₁ are functions of qₜ (see equations (6) and (7)) and thus depend on the decision variables in period t. The product (1−Fₜ Σᵢ₌₁ⁿ qᵢₜ) (1+βHₜ Σᵢ₌₁ⁿ qᵢₜ) is equal to

$$\frac{{F}_{t + 1} {H}_{t + 1}}{{F}_{t} {H}_{t}} ,$$

namely, the ratio of the number of customers facing a purchase occasion in period t+1 to that in period t. Therefore, from (11) and the definition of \ddot{G}ₜ*, the value-to-go Jₜ as defined in equation (11) is equivalent to

Jₜ(Hₜ,Fₜ)=FₜHₜGₜ*(Hₜ,Fₜ). (14)

Hence, to solve the optimal prices, it suffices to solve (13).

It is useful to interpret Gₜ. Recall that FₜHₜ represents the number of customers facing a purchase decision at time t. From (14), Gₜ measures the expected profit “amortized” over the current number of customers facing purchase decisions, which includes potential profit from this customer and those that he/she will influence through word-of-mouth. The first term in equation (12) signifies the expected period-t profit from a customer who faces a purchase decision in this period; the second term is the expected future profit amortized over the number of customers who face a purchase decision now. The price decision in period t, therefore, affects the immediate profit in this period and affects future profit through its impact on the remaining market potential Hₜ₊₁ and on the diffusion intensity Fₜ₊₁. Since the relationship is recursive, decision on qₜ affects not only Gₜ₊₁*, but also Gₜ₊₂* through Fₜ₊₂ and Hₜ₊₂, Gₜ₊₃* through Fₜ₊₃ and Hₜ₊₃, and so on. This leads to a complex dependency that is polynomial and does not appear to provide a clear path for characterization. In the present disclosure, a novel solution approach is presented that circumvents this complexity. Using this approach, the present disclosure is able to show not only that the profit optimization has a unique price solution, but also that the solution can be efficiently obtained and the optimal price trend can be analytically characterized.

### Reduction of the Choice Probability Vector Oat to a Single Variable θₜ

Given the relationships in (12), it should be clear that the choice of optimal prices in period t depends on previous price decisions, {pₛ}_{s=1, . . . , t-1}, only through Fₜ and Hₜ. Further, the definitions of Fₜ and Hₜ imply

Fₜ=α+β(M−Hₜ),

hence Fₜ is viewed as a linear function of Hₜ and rewrite (12) and (13) as

$${G}_{t} ( {H}_{t} , {q}_{t} ) := {\sum }_{i = 1}^{n} ( {p}_{it} ( {q}_{t} ) - {c}_{it} ) {q}_{it} + ( 1 - {F}_{t} ( {H}_{t} ) {\sum }_{i = 1}^{n} {q}_{it} ) ( 1 + β {H}_{t} {\sum }_{i = 1}^{n} {q}_{it} ) {G}_{t + 1}^{*} ( {H}_{t + 1} ( {H}_{t} , {q}_{t} ) )$$

$$where {p}_{it} ( {q}_{t} ) = \frac{1}{{b}_{t}} ( {a}_{it} - log \frac{{q}_{it}}{1 - {\sum }_{j = 1}^{n} {q}_{jt}} ) , \\ {F}_{t} ( {H}_{t} ) = α + β ( M - {H}_{t} ) , \\ {H}_{t + 1} ( {H}_{t} , {q}_{t} ) = {H}_{t} ( 1 - {F}_{t} ( {H}_{t} ) {\sum }_{i = 1}^{n} {q}_{it} ) and$$

$${G}_{t}^{*} ( {H}_{t} ) = {max}_{{q}_{it} ∈ [ 0 , 1 ] , i = 1 , … , n} {G}_{t} ( {H}_{t} , {q}_{t} ) .$$

For notation brevity, the function arguments of Fₜ(Hₜ), Hₜ₊₁(Hₜ, qₜ), Gₜ(Hₜ, qₜ) and Gₜ*(Hₜ) are suppressed where there is no ambiguity, and write them as Fₜ, Hₜ₊₁, Gₜ and Gₜ* for the remainder of the paper.

Take the first-order partial derivative of Gₜ with respect to qᵢₜ and set it to zero to obtain a necessary condition for optimality:

$${p}_{it} ( {q}_{t} ) - {c}_{it} - \frac{1}{{b}_{t}} = {\sum }_{{i}^{′} = 1}^{n} \frac{{q}_{{i}^{′} t}}{{b}_{t} ( 1 - {\sum }_{j = 1}^{n} {q}_{jt} )} + ( {F}_{t + 1} - β {H}_{t + 1} ) {G}_{t + 1}^{*} + {F}_{t + 1} {H}_{t + 1} \frac{{dG}_{t + 1}^{*}}{d {H}_{t + 1}} . \qquad ( 15 )$$

where the relationships in (6) and (7) are used to simplify the expression.

Note that the right hand side of the above is independent of the index i, which implies that, at optimality, there exists θt such that

$${p}_{it} - {c}_{it} - \frac{1}{{b}_{t}} = {θ}_{t}$$

for all i. That is, the optimal markup, subtracting the reciprocal of price sensitivity, is symmetric across products, which generalizes the “equal-adjusted-markup” property to the multi-period diffusion setting. This observation can simplify the problem. In particular, the price and choice probability are expressed as functions of θt

$$\begin{matrix}{p}_{it} ( {θ}_{t} ) = {θ}_{t} + {c}_{it} + \frac{1}{{b}_{t}} , & ( 16 ) \\ {q}_{it} ( {θ}_{t} ) = \frac{exp ( {a}_{it} - 1 - {b}_{t} {θ}_{t} - {b}_{t} {c}_{it} )}{1 + {\sum }_{j = 1}^{n} exp ( {a}_{jt} - 1 - {b}_{t} {θ}_{t} - {b}_{t} {c}_{jt} )} , & ( 17 )\end{matrix}$$

and consider a revised optimization problem over θₜ, t=1, . . . , T. Gₜ(Hₜ, qₜ) is rewritten as

$$\begin{matrix}{\tilde{G}}_{t} ( {H}_{t} , {θ}_{t} ) = {\sum }_{i = 1}^{n} ( {p}_{it} ( {θ}_{t} ) - {c}_{it} ) {q}_{it} ( {θ}_{t} ) + ( 1 - {F}_{t} ( {H}_{t} ) {\sum }_{i = 1}^{n} {q}_{it} ( {θ}_{t} ) ) ( 1 + β {H}_{t} {\sum }_{i = 1}^{n} {q}_{it} ( {θ}_{t} ) ) {\tilde{G}}_{t + 1}^{*} ( {H}_{t + 1} ) & ( 18 ) \\ where {H}_{t + 1} = {H}_{t} ( 1 - {F}_{t} ( {H}_{t} ) {\sum }_{i = 1}^{n} {q}_{it} ( {θ}_{t} ) ) , & ( 19 ) \\ {\tilde{G}}_{t}^{*} ( {H}_{t} ) = {max}_{{θ}_{t}} {\tilde{G}}_{t}^{*} ( {H}_{t} , {θ}_{t} ) . & ( 20 )\end{matrix}$$

Hence, an n-dimension optimization has been reduced in each period t to a 1-dimension problem. Nonetheless, the longitudinal complexity is still prohibitive. In the next step, a connection is established between the optimal θₜ values of two adjacent time periods, which forms a crucial building block of our solution approach.

Relationship Between θₜ and θₜ−1 at Optimality

With the transformation of the choice probability vector to a single variable θₜ, the first-order necessary condition of optimality becomes

$$\begin{matrix}{θ}_{t} = {\sum }_{i = 1}^{n} \frac{{q}_{it} ( {θ}_{t} ) / {q}_{0 t} ( {θ}_{t} )}{{b}_{t}} + ( {F}_{t + 1} - β {H}_{t + 1} ) {\tilde{G}}_{t + 1}^{*} + {F}_{t + 1} {H}_{t + 1} \frac{d {\tilde{G}}_{t + 1}^{*}}{d {H}_{t + 1}} & ( 21 ) \\ where {q}_{0 t} ( {θ}_{t} ) = 1 - {\sum }_{i = 1}^{n} {q}_{it} ( {θ}_{t} ) . & \\ Note {q}_{it} / {q}_{0 t} = {e}^{{α}_{it} - 1 - {b}_{t} {c}_{it} - {b}_{t} {θ}_{t}} and define & \\ {r}_{t} ( {θ}_{t} ) := {θ}_{t} - {\sum }_{i = 1}^{n} \frac{{e}^{{α}_{it} - 1 - {b}_{t} {c}_{it} - {b}_{t} {θ}_{t}}}{{b}_{t}} , & \\ {Λ}_{t} := {F}_{t} {H}_{t} \frac{d {\tilde{G}}_{t}^{*}}{d {H}_{t}} . & \end{matrix}$$

Then the first-order condition is equivalent to

rₜ(θₜ)=(Fₜ₊₁−βHₜ₊₁)\tilde{G}ₜ₊₁*+Aₜ₊₁,t≤T. (22)

This transformed first-order condition for the period t decision of θₜ reveals a clear balance between the marginal impact on current (i.e., left side of (22)) and future (i.e., right side of (22)) periods. In a myopic single-period decision setting, only rₜ(θₜ) is relevant and the optimal decision solves rₜ(θₜ)=0. With future periods in consideration, it is necessary to quantify the values of (Fₜ₊₁−βHₜ₊₁)\tilde{G}ₜ₊₁*+Λₜ₋₁. A direct quantification is impractical due to the high computation load, the difficulty of computing the derivative

$$\frac{d {\tilde{G}}_{t + 1}^{*}}{d {H}_{t + 1}} ,$$

and the fact that is is unclear whether the optimal solution of θₜ is even uniquely identifiable. Instead, by connecting the optimal values of θₜ with that of its adjacent period, the uniqueness of the optimal solution can be established and the complexity of the problem can be dramatically reduced.

To accomplish this, two recursive relationships may be used. Substituting (16) into (18) yields

$${\tilde{G}}_{t}^{*} ( {H}_{t} ) = {θ}_{t} {\sum }_{i = 1}^{n} {q}_{it} + {\sum }_{i = 1}^{n} \frac{{q}_{it}}{{b}_{t}} + \frac{{F}_{t + 1}}{{F}_{t}} \frac{{H}_{t + 1}}{{H}_{t}} {\tilde{G}}_{t + 1}^{*} ( {H}_{t + 1} ) . \qquad ( 23 )$$

In addition, it can be shown that

$${Λ}_{t} = ( \frac{{F}_{t + 1}}{{F}_{t}} + \frac{{H}_{t + 1}}{{H}_{t}} ) ( {F}_{t + 1} - {F}_{t} ) {\tilde{G}}_{t + 1}^{*} + ( \frac{{F}_{t + 1}}{{F}_{t}} + \frac{{H}_{t + 1}}{{H}_{t}} - 1 ) {Λ}_{t + 1} . \qquad ( 24 )$$

From the recursive relationships in (23) and (24), as well as the first order condition in (22), a connection between the optimal solutions of two adjacent time periods may be established.
Lemma 1. Let θₜ* and θt₋₁* be the optimal solution at time t and t−1 respectively for i=2, . . . , T. Then

$${r}_{t - 1} ( {θ}_{t - 1}^{*} ) - {r}_{t} ( {θ}_{t}^{*} ) = ( {F}_{t} - β {H}_{t} ) {\sum }_{i = 1}^{n} \frac{{e}^{{α}_{it} - 1 - {b}_{t} {c}_{it} - {b}_{t} {θ}_{t}^{*}}}{{b}_{t}} .$$

The relationship in Lemma 1 is much simpler and easier to quantify than the first-order condition (22). It is not only crucial for establishing uniqueness of the optimal solution and efficiently solving for it, but also useful for characterizing the optimal price trend, as shown herein.

### Uniqueness and Solution Algorithm

It is clear from the problem formulation in (18)-(20) that the optimal θₜ is a function of the remaining market potential at period t, Hₜ. Let θₜ*(Hₜ) solve the optimization in (18)-(20) for any given Hₜ. Rewrite the relationship in Lemma 1 as

$${r}_{t - 1} ( {θ}_{t - 1}^{*} ) = {r}_{t} ( {θ}_{t}^{*} ) + ( {F}_{t} - β {H}_{t} ) {\sum }_{i = 1}^{n} \frac{{e}^{{a}_{it} - 1 - {b}_{t} {c}_{it} - {b}_{t} {θ}_{t}^{*}}}{{b}_{t}} . \qquad ( 25 )$$

We express the right side of (25) as a function of Hₜ and define

$${g}_{t} ( {H}_{t} ) := {r}_{t} ( {θ}_{t}^{*} ( {H}_{t} ) ) + ( {F}_{t} ( {H}_{t} ) - β {H}_{t} ) {\sum }_{i = 1}^{n} \frac{{e}^{{a}_{it} - 1 - {b}_{t} {c}_{it} - {b}_{t} {θ}_{t}^{*} ( {H}_{t} )}}{{b}_{t }} .$$

From (19), Hₜ=Hₜ₋₁(1−Fₜ₋₁(Hₜ₋₁)Σᵢ₌₁ⁿ q_{i,t-1}(θₜ₋₁)) is a function of Hₜ₋₁ and θₜ₋₁; we further define ĝₜ(Hₜ₋₁, θₜ₋₁):=gₜ(Hₜ(Hₜ₋₁, θₜ₋₁)). Therefore, according to (25), the optimal solution θₜ₋₁*(Hₜ₋₁) must satisfy

rₜ₋₁(θₜ₋₁)=ǵₜ(Hₜ₋₁,θₜ₋₁),t=2, . . . ,T. (26)

Given Hₜ₋₁, this is a single-variable equation for θₜ₋₁. From this, uniqueness of the optimal solution may be established and an efficient method may be constructed to solve for it, as summarized in the following proposition.
Proposition 1. (i) For any given Hₜ, there exists a unique solution θₜ*(Hₜ) which maximizes \ddot{G}ₜ(Hₜ, θₜ).

$$\frac{d {θ}_{t}^{*} ( {H}_{t} )}{{dH}_{t }} \leq 0.$$

(iii) Suppose θₜ₋₁*(Hₜ₋₁) is the unique optimal solution in period t+1 for any given Hₜ₊₁. Then for any given Hₜ, θₜ*(Hₜ) is the unique root to

$${r}_{t} ( {θ}_{t} ) = {\hat{g}}_{t + 1} ( {H}_{t} , {θ}_{t} ) \\ where \frac{{dr}_{t} ( {θ}_{t} )}{d {θ}_{t}} > 0 and \frac{\partial {\hat{g}}_{t + 1} ( {H}_{t} , {θ}_{t} )}{\partial {θ}_{t}} < 0. \qquad ( 27 )$$

The proof relies on inductively showing (i) and (ii) jointly, using the relationship in equation (26). Furthermore, equation (27) can be solved efficiently with a bisection search since the left side monotonically increases and the right side monotonically decreases in θₜ, leading to the following algorithm for computing qₜ* for all t=1, . . . , T.

### Algorithm 1 (Solution Procedure)

(i) First, solve the period T problem. Since \ddot{G}_{T+1}*=0, solve r_{T}(θ_{T}*)=0 to obtain θ_{T}* and then let

$${p}_{iT}^{*} = {c}_{iT} + \frac{1}{{b}_{t}} + {θ}_{T}^{*} .$$

(ii) Next, for t=T−1, T−2, . . . , 1, discretize the plausible range for Hₜ, e.g., [0,1], to N_{H} grid points. For each Hₜ value, solve the single-variable equation (27) via bisection search to obtain θₜ*(Hₜ). Specifically, given Hₜ, the left hand side of equation (27), i.e., rₜ(θₜ) is computed according to

$${r}_{t} ( {θ}_{t} ) = {θ}_{t} - {\sum }_{i = 1}^{n} \frac{{e}^{{a}_{it} - 1 - {b}_{t} {c}_{it} - {b}_{t} {θ}_{t}}}{{b}_{t}} ,$$

and the right hand side of equation (27), i.e., \ddot{g}ₜ₊₁(Hₜ, θₜ), is computed according to the relationships:

$${\hat{g}}_{t + 1} ( {H}_{t} , {θ}_{t} ) = {g}_{t + 1} ( {H}_{t + 1} ( {H}_{t} , {θ}_{t} ) ) , \\ {H}_{t + 1} = {H}_{t} ( 1 - {F}_{t} ( {H}_{t} ) {\sum }_{i = 1}^{n} {q}_{i , t} ( {θ}_{t} ) ) , \\ {g}_{t + 1} ( {H}_{t + 1} ) = {r}_{t + 1} ( {θ}_{t + 1}^{*} ( {H}_{t + 1} ) ) + ( {F}_{t + 1} ( {H}_{t + 1} ) - β {H}_{t + 1} ) {\sum }_{i = 1}^{n} \frac{{e}^{{a}_{it + 1} - 1 - {b}_{i + 1} {c}_{it + 1} - {b}_{it + 1} {θ}_{i + 1}^{*} ( {H}_{t + 1} )}}{{b}_{it + 1}} .$$

(iii) Finally, identify the path of optimal prices and sales from the initial value H₁=M−Y₀ for t=1, 2, . . . , T−1 according to

$${θ}_{t}^{*} = {θ}_{t}^{*} ( {\hat{H}}_{t} ) , \\ {p}_{it}^{*} = {θ}_{t}^{*} + {c}_{it} + \frac{1}{{b}_{t}} , \\ {q}_{it}^{*} = \frac{exp ( {a}_{it} - 1 - {b}_{t} {θ}_{t}^{*} - {b}_{t} {c}_{it} )}{1 + {\sum }_{j = 1}^{n} exp ( {a}_{jt} - 1 - {b}_{t} {θ}_{t}^{*} - {b}_{t} {c}_{jt} )} , \\ {Z}_{it}^{*} = [ α + β ( M - {H}_{t} ) ] {H}_{t} {q}_{it}^{*} , \\ {H}_{t + 1} = {H}_{t} \{ 1 - [ α + β ( M - {H}_{t} ) ] {\sum }_{i = 1}^{n} {q}_{it}^{*} \} .$$

In the single product adoption model (which is a single-product diffusion-choice model), the above procedure applies with n=1. In other models (which may not consider the imitation effect), it turns out that with α=1 and β=0, the problem becomes independent of the remaining market potential Hₜ. In particular, (12) reduces to

$${\hat{G}}_{t} = {\sum }_{i = 1}^{n} ( {p}_{it} ( {q}_{t} ) - {c}_{it} ) {q}_{it} + ( 1 - {\sum }_{i = 1}^{n} {q}_{it} ) {\hat{G}}_{t + 1}^{*} \qquad ( 28 )$$

which is concave in qₜ and independent of Hₜ, leading to an even simpler solution. Proposition 2. In the models for which α=1 and β=0,
(i) \acute{G}ₜ is concave in qₜ=(q₁ₜ, q₂ₜ, . . . , qₙₜ).
   (ii) let pₜ* be the unique solution to

$${ρ}_{t} = {\sum }_{i = 1}^{n} \frac{1}{{b}_{t}} exp ( {a}_{it} - 1 - {b}_{t} {c}_{it} - {b}_{t} {ρ}_{t} ) + {G}_{t + 1}^{*} . \qquad ( 29 )$$

Then \acute{G}ₜ*=pₜ*.
(iii) the optimal pricing solution is given by

$$\begin{matrix}{p}_{it}^{*} = {c}_{it} + \frac{1}{{b}_{t}} + {\hat{G}}_{t}^{*} , & ( 30 ) \\ {q}_{it}^{*} = \frac{exp ( {a}_{it} - 1 - {b}_{t} {c}_{it} - {b}_{t} {\hat{G}}_{t}^{*} )}{1 + {\sum }_{j = 1}^{n} exp ( {a}_{jt} - 1 - {b}_{t} {c}_{jt} - {b}_{t} {\hat{G}}_{t}^{*} )} . & ( 31 )\end{matrix}$$

when \acute{G}ₜ* is solved backward in time according to (29) and Ĝ_{T+1}*=0.
   When diffusion is driven predominantly by the innovation effect, the solution given in Proposition 2 suffices, which is simple to obtain due to independency on Hₜ.

### Properties of Optimal Solution

Lemma 1 implies

rₜ₋₁(θₜ₋₁*)≤rₜ(θₜ*) if and only if Fₜ≤βHₜ. Recall that Hₜ measures the remaining market potential which decreases with time and Fₜ measures the diffusion intensity which increases with time. Hence the term (Fₜ−βHₜ) monotonically increases in t; if the planning horizon covers a majority of the product's life cycle, this term should shift from negative to positive and crosses zero only once as t increases. Let t̅ be the time period at which (Fₜ−βHₜ) switches from negative to positive. If the planning horizon only covers a portion of the product life cycle such that (Fₜ−βHₜ) is negative (positive) throughout the planning horizon, then t̅=T (t̅=1).

As a result, rₜ(θₜ*), and consequently θₜ* change in a predictable manner with respect to time.
Corollary 1. There exists t̅∈{1, . . . , T} such that rₜ₋₁(θₜ₋₁*)≤rₜ(θₜ*) if t<t̅ and rₜ₋₁(θₜ₋₁*)≥rₜ(θₜ*) if t≥t̅ when t=1, . . . , T.

In the special case for which the cost and price sensitivity are time invariant, we can characterize the time trend of the optimal prices.
Corollary 2. Suppose product qualities, cost and price sensitivities are time-invariant, i.e., aᵢₜ=aᵢ, bᵢ=b and cᵢₜ=cᵢ for i=1, . . . , n; t=1, . . . , T. Then, there exists \ddot{t}∈{1, . . . , T} such that θₜ₋₁*≤θₜ* if t≤\ddot{t} and θᵢ₋₁≥θₜ if t≥\ddot{t}, In addition, p_{i,t-1}*≤p_{i,t}* if t≤\ddot{t} and p_{i,t-1}*≥p_{i,t}*, if t≥\ddot{t}.

Thus with time-invariant quality, cost and price sensitivity, the optimal prices of all products exhibit an up-and-then-down time trend. In special case models, it can be shown that the optimal price trend is a monotonic descending one.
Corollary 3. Suppose α=1 and β=0. Then (i) \acute{G}ₜ^{x} decreases in t. (ii) Suppose that aⱼₜ, bₜ, and cⱼₜ stay constant over time. Then the optimal price of each product, given by pᵢₜ*, i=1, 2, . . . , n, decreases in t.

The difference of price trend between the special case models and the general model reflects the impact of the imitation effect. In the absence of imitation, the term Ĝₜ* decreases in time, implying that the average profit from a customer remaining in the potential customer population decreases with time, which leads to decreasing prices. Intuitively, as time progresses, the time window to capture the remaining customers shortens; to counteract this effect, the firm has to lower prices to make the products more attractive. With imitation, the firm has an incentive to set the price low initially so as to speed up the word-of-mouth effect; this is most effective early in the diffusion. As the diffusion progresses, the firm faces a smaller pool of remaining customers and a shrinking time window to capture them and thus the pressure to reduce price increases over time. Samsung, for example, is reported to have priced its smart phones with such an up-and-then-down trend. This highlights the importance of aligning a firm's product introduction and pricing strategy with product diffusion characteristics: Optimal pricing strategy should be stage-dependent in a product life cycle; products that rely more on word-of-mouth for adoption are better candidates for discounted introduction prices than others.

A similar effect has been documented in the existing literature for a single-product diffusion—with strong word-of-mouth effect, it is optimal to use penetration pricing (i.e., increase price initially and decrease price later); with weak work-of-mouth, it is optimal to price skim (i.e., monotonically decrease price). This has been generalized to the setting of multiple substitutable products, and the relationships in Lemma 1 and equation (16) quantify period-to-period price changes for every product in the choice set, which were not available in prior models. As shown later in the present disclosure, these relationships continue to hold for sequential product introductions, making the method a robust tool for analyzing price trend in a much broader context. In addition, our model allows more general price trend to be justified by the effect of diffusion as well as time-variant product qualities, price sensitivity, and cost; in this case, the price trend becomes further compounded with the time trend of these parameters. For example, since the optimal prices are given by

$${p}_{it}^{*} = {c}_{it} + \frac{1}{{b}_{t} } + {θ}_{t}^{*} , \qquad ( 32 )$$

it is evident that increasing price sensitivity and declining cost will superimpose additional descending trend on the optimal prices, and with the present solution method, these impacts are easily quantified. Therefore, firms can use estimate on cost reduction (or price sensitivity change) to quantitatively project the optimal pricing strategy and diffusion path of each product over the product life cycle. Such capability facilitates other strategic decisions such as capacity or inventory planning. The common term θₜ* depends on properties of all products, which identifies the common price trend, emphasizing the need for joint determination of pricing and other planning decisions.

Since the present model captures product interactions through the choice model, the present model may compare the prices and price trends of individual products under consideration, which is beyond the capability of existing models discussed earlier. From (32), we obtain the familiar “equal mark-up” property which is well-known for pricing under the MNL demand. Under this property, the product with higher cost is priced higher.
Corollary 4. For any two products i≠j, pᵢₜ*−cᵢₜ=pⱼₜ*−cⱼₜ, i.e., pᵢₜ*≥pⱼₜ* if and only if cᵢₜ≥cᵢⱼ.

The choice probabilities and sales, however, are not equal across products, but instead differ across products based on product quality. The next corollary shows that products with higher “net quality” (i.e., higher ai−bci values) will, ceteris paribus, have higher swing in sales, i.e., steeper declining or increasing trend, than low net-quality products.
Corollary 5. Suppose aᵢₜ=aᵢ, cᵢₜ=cᵢ and bₜ=b for all i,t. If aᵢ−bcᵢ>aⱼ−bcⱼ for i≠j then at the optimal price solution, |q_{i,t-1}*−q_{i,t}*|>|q_{j,t-1}*−q_{j,t}*| and |Z_{i,t-1}*−Z_{i,t}*|>|Z_{j,t-1}*−Z_{j,t}*| for t=2, . . . , T.

Therefore, the gap between peak and non-peak sales is larger for high-end products than for low-end products. This has important implications for inventory and capacity decisions as products with larger demand swing are harder to manage and require more careful planning.

Lastly, we comment on the diffusion under the optimal prices. Note that the sales under the optimal path are given by

$${Z}_{it} = \frac{{F}_{t} {H}_{t} exp ( {a}_{it} - 1 - {b}_{t} {θ}_{t}^{*} - {b}_{t} {c}_{it} )}{1 + {\sum }_{j = 1}^{n} exp ( {a}_{jt} - 1 - {b}_{t} {θ}_{t}^{*} - {b}_{t} {c}_{jt} )} .$$

Hence, although FₜHₜ implies how the overall diffusion evolves over time, the exact time when sales peak for each product depends on the values of aᵢₜ−bₜcᵢₜ.

For example, all else equal, a product with faster value depreciation will reach sales peak sooner than others while a product with faster cost reduction may stay near the peak level for a longer period of time, i.e., starts to see sales decline later than other products (as the firm is able to optimally reduce price of this product at a faster speed than for other products). Therefore, using our model, one can project not only the optimal pricing strategy, but also how each individual product diffuses into the market under the optimal pricing strategy given the projections of aᵢₜ, bₜ and cᵢₜ over time.

### Numerical Illustration

The solution method we have developed in Section 4 applies to any intertemporal pattern of parameters aᵢₜ, bₜ and cᵢₜ. However, conclusive analytical properties of the price trend can only be said when restricting to particular parameter patterns. Next, we numerically examine the impact of diffusion dynamics, the effect of product quality, price sensitivity and cost as well as the compounding effect of their intertemporal trend. This is illustrated with a single-product case as figures plotting the time trends of multiple products under varying parameter values are illegible. To illustrate the effect of product interactions, multiple product scenarios are presented herein and both the breadth (i.e., the number of products) and the depth (i.e., quality differences) of product variety are considered.

### Effects of Diffusion Parameters, Product Quality, and Price Sensitivity

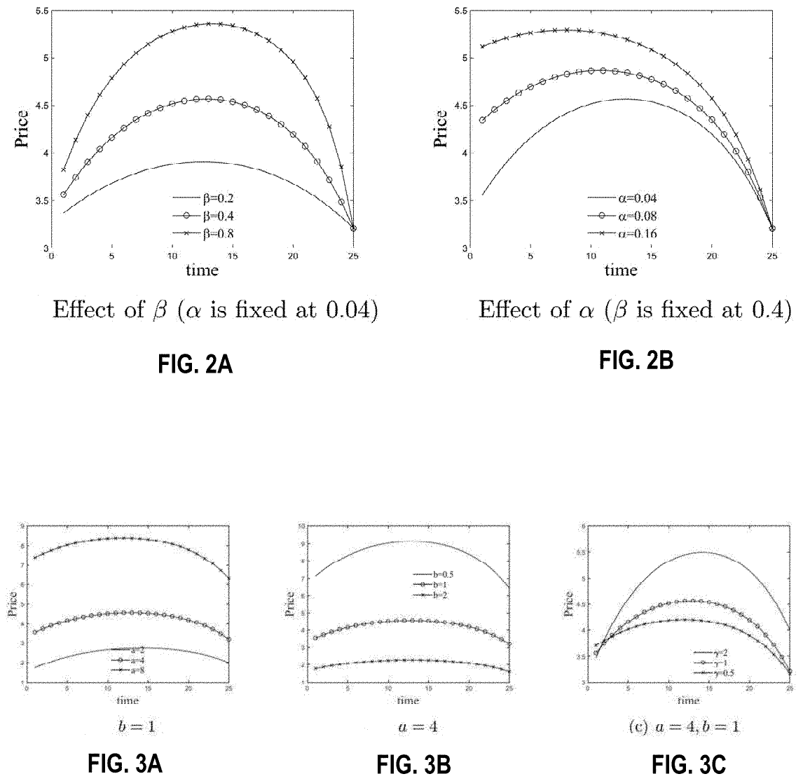

In previous works, as well as in subsequent applications, products of different categories exhibited distinctive diffusion characteristics, which are reflected in the relative magnitude of innovation versus imitation effect. In the examples shown in FIG. 2, we compute the optimal price path is computed by varying the values of α and β while keeping other parameter values fixed with M=1, Y₀=0, T=25; the quality, cost and price sensitivity are held constant at aₜ=4, bₜ=1, cₜ=0 for t=1, . . . , T in order to focus on the diffusion effect. As the imitation effect β increases, the optimal price displays a steeper up-and-then-down trend, which is in agreement with the discussion following Corollary 2. However, as the innovation effect a becomes more dominant (FIG. 2B), the initial price is to be set higher, which offsets the imitation-driven initial upward price trend and ultimately leads to a predominantly descending price trend.

The effect of product quality a and price sensitivity b are illustrated in FIGS. 3A and 3B respectively. As expected, higher quality or lower price sensitivity leads to higher prices. In the literature, a common scale factor of a and b parameters is interpreted as a measure for the cognitive limitations of customers, i.e., choice probability is given by

$${q}_{i} = \frac{{e}^{{u}_{i} / γ}}{{\sum }_{j = 0}^{n} {e}^{{u}_{j} / γ}}$$

with large γ values indicating less rational choice behaviors. FIG. 3C shows how such customer rationality affects the optimal prices by scaling down values of a and b by a common parameter γ. As consumer rationality decreases (i.e., γ increases), the optimal prices are generally higher, which is intuitive since customers are less able to differentiate between good and poor choices (i.e., less sensitive to price or quality differences). In addition, larger internal price adjustments were observed for higher γ values, which is less intuitive but also reflects the firm's adaptation to reduced rationality—with irrational customers, it takes a larger initial discount to induce word-of-mouth as well as a larger markdown later in the diffusion to counteract the depletion of potential customers.

### Effect of Time-Varying Price Sensitivity and Cost

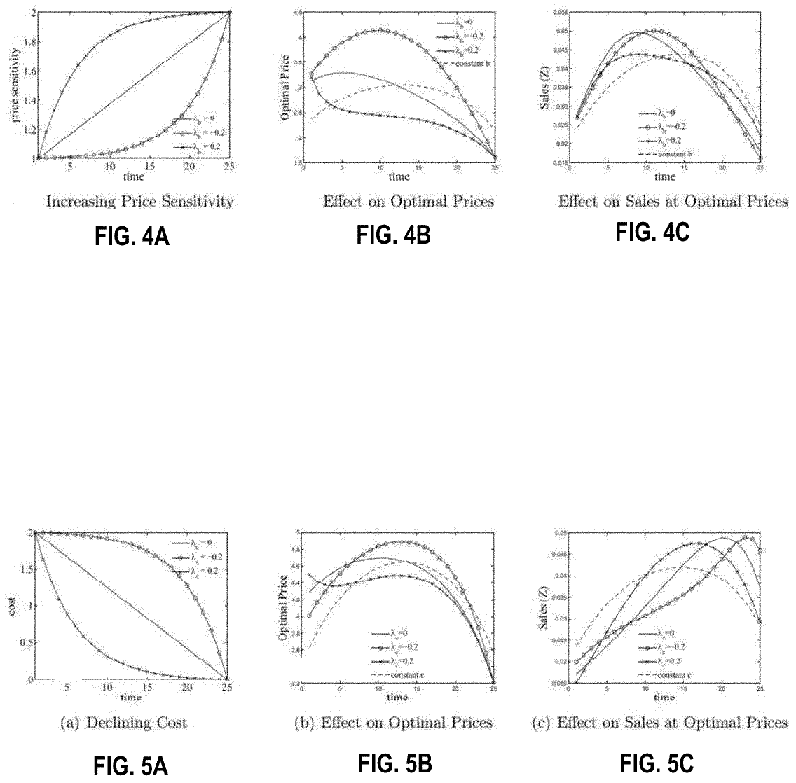

While the examples in FIGS. 2A and 2B have time-invariant cost and price sensitivity (so as to isolate the effect of diffusion on prices), in most realistic settings these vary with time and typically cost declines over time and price sensitivity increases over time. FIGS. 4A-4C illustrate the optimal price path and the corresponding sales for each price sensitivity curve specified in FIG. 4A where the curve is concave (convex) when λ_{b}>0 (λ_{b}<0) and linear when λ_{b}=0. For reference, the optimal price path and sales for constant price sensitivity were also included with b(t)=(b₁+b_{T})/2, shown as the dashed curve. Evidently, the optimal price displays a stronger declining trend with increasing price sensitivity than with constant b. With sharply increasing price sensitivity (λ_{b}=0.2), we obtain a monotonically descending price trend, masking any imitation-driven upward price trend (FIG. 48). In addition, with increasing price sensitivity, peak sales occur earlier in the planning horizon because the firm has a stronger incentive to sell early when the market is less price-sensitive (FIG. 4C).

FIG. 5 shows that declining cost (FIG. 5A) results in a stronger downward price trend (FIG. 5C) and delayed peak sales (FIG. 5C) relative to constant cost (which is fixed at cₜ=(c₁+c_{T})/2 and shown as the dashed curve). That is, anticipating cost decline and potentially higher margin later in time, the firm finds it more profitable to delay peak sales; like in the case of increasing price sensitivity, this dampens the imitation-driven upward price trend. Interestingly, although both price-sensitivity increase and cost decline reduce the upward price trend during the early stage of diffusion, the former accelerates peak sales whereas the latter postpones peak sales.

### Effect of Product Interactions

To isolate the effect of product interactions, we consider examples with time-invariant qualities, costs, and price sensitivities.

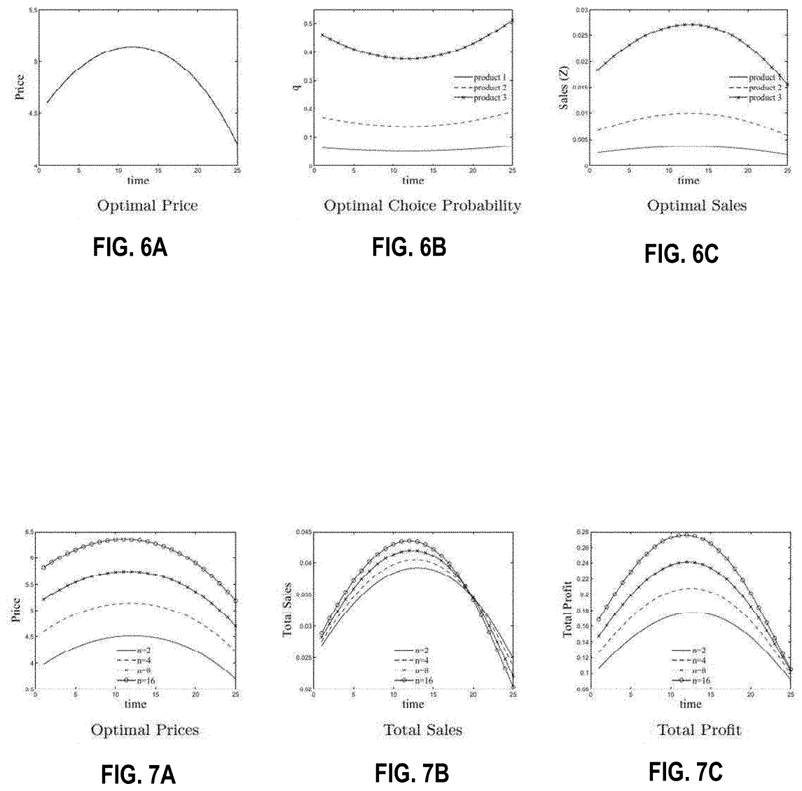

Let M=1, Y₀=0, T=25, α=0.04, β=0.2, n=3, a₁ₜ=3, a₂ₜ=4, a₃ₜ=5, bᵢₜ=1, cᵢₜ=0 for t=1, . . . , T. Apply algorithm 1 to obtain the optimal θₜ, pᵢₜ, qᵢₜ and Zᵢₜ for i=1, 2, 3 and t=1, . . . , T. Since cost and price sensitivity are symmetric across products and time-invariant, the optimal prices of the products are equal and given by pᵢₜ*=cᵢₜ+1/bₜ+θₜ=1+θₜ. FIGS. 6A-6C illustrate the optimal price, choice probability and sales, respectively. Note that the phenomenon identified in Corollary 5 is apparent: Not only are sales and choice probability of the high-quality product (product 3 with a₃ₜ=5) much higher, but they also exhibit stronger time trend (i.e., larger swing) than the low-quality product (product 1 with a₁ₜ=3).

Next, how the breadth of product variety is examined, measured by the number of products offered in the choice set, affects the optimal solution. For the ease of comparison, we let aᵢₜ=4 for i=1, . . . , n, t=1, . . . , T and vary n while keeping all other parameters the same as in FIGS. 6A-6C.

In addition, with more product options for the customers, the diffusion takes off more rapidly and reaches peak sooner. A similar pattern is observed for the optimal prices, which can be explained when considered in conjunction with diffusion: By adding breadth (i.e., more products), the firm is able to capture more customers early on, which speeds up the diffusion and consequently lessens the imitation-driven upward price trend but strengthens the depletion-driven downward price trend; this results in the optimal prices declining sooner. Such observations may help justify firms' strategy of introducing multiple variations of a new product, although the increased profit shown in FIG. 7C need be balanced with the cost of managing more product variety which is omitted here.

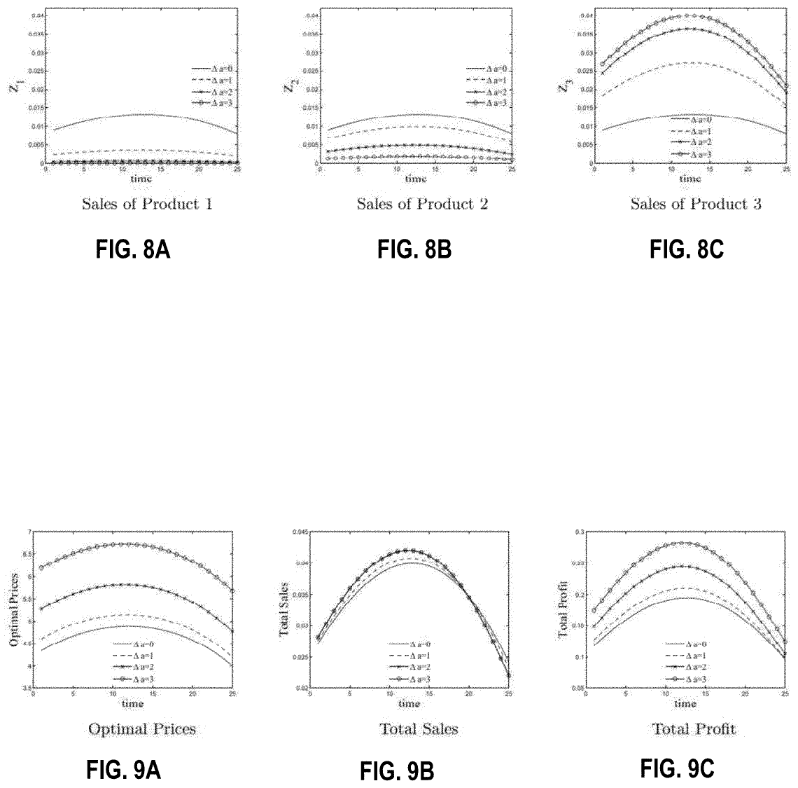

FIG. 9 illustrates the effect of depth of product variety, measured by the quality differences among products. The present disclosure lets a₁ₜ=4−Δa, a₂ₜ=4, and a₃ₜ=4+Δa for t=1, . . . , T and varies the value of Δa (other parameters are the same as in FIGS. 6A-8C). As the depth (i.e., Δa) increases, the optimal solution becomes increasingly dominated by the highest-quality product (i.e., product 3) as shown in FIGS. 8A-8C. As a result, not only is the firm able to charge higher prices (FIG. 9A), but it also achieves a faster diffusion (FIG. 9B) and a higher profit (FIG. 9C). Therefore, having a more competitive leading product (versus three average products) accelerates the diffusion and benefits the firm.

### Extensions

### Sequential Product Introductions

As discussed herein, the present disclosure has examined multiple substitute products going through diffusion concurrently. In practice, these products may be introduced non-concurrently but with overlapping periods of sales. For example, Amazon sometimes introduces the paperback version of a book a few months after the hardcover version. Technology firms often introduce successive generations of products which are substitutes of one another and have overlapping sales. Indeed, some of the special case models consider such a scenario. Researchers have extended the Bass and similar models to address diffusion of overlapping product generations. Most prominently, other works assume that the adoption of the next generation product originates from both the untapped market potential and from adopters of the previous generation upgrading to the new product. Their model, however, only addresses substitution between adjacent generations, not across multiple generations; it grows increasingly more complex with additional number of products and it is not clear how one can incorporate prices and product characteristics without making the model intractable. A related stream of work builds upon the population growth model on the demand for IBM mainframe computers, on subscriptions of telecommunication services, and on sales of microprocessors. These models perform well for fitting empirical data, but offer poor tractability for price optimization. Normative price optimizations based on existing multi-product diffusion models are few and are typically in a stylized setting with only two products, which yields strategic insight but is unsuitable for decision support. The present disclosure will show that the mathematical model presented herein can be extended to this scenario. A clear advantage of this extension over the multi-product diffusion model discussed above is that product attributes and their effects on demand interactions can be easily and consistently incorporated and that the number of products has little effect on the computation complexity.

Let Mₜ be the total market potential at the beginning of period t, which may be adjusted based on market change. For example, when a new product is introduced, Mₜ may change due to additional market potential brought forth by the new product. This modeling choice is commonly adopted in the literature for successive product generations. Let kₜ be the set of products being offered at time t. As new products are introduced or old products are retired over time, the set kₜ and the total market potential Mₜ evolve accordingly. Assuming that Mₜ and kₜ are both exogenously given, we solve the pricing problem. The choice probability for product i, i∈kₜ in period t is

$${q}_{it} = \frac{exp ( {a}_{it} - {b}_{t} {p}_{it} )}{1 + {\sum }_{j ∈ {κ}_{t}} exp ( {a}_{jt} - {b}_{t} {p}_{jt} )}$$

and the demand for product i in period t is given by Zᵢₜ=(Mₜ−Yₜ₋₁)(α+βYₜ₋₁)qᵢₜ, where Yₜ=Σₛ₌₁ⁱΣ_{i∈n}_{ₛ} Zᵢₛ. From this, we can derive

$${M}_{t + 1} - {Y}_{t} = Δ {M}_{t + 1} + ( {M}_{t} - {Y}_{t - 1} ) [ 1 - ( α + β {Y}_{t - 1} ) {\sum }_{i ∈ {κ}_{t}} {q}_{it} ]$$

where ΔMₜ:=Mₜ−Mₜ₋₁. It is noted the two main differences in the problem formulation for the sequential introduction model: (i) the set of product kₜ is allowed to change with time, (ii) there is a period-to-period change ΔM, for the total market potential.

It can be shown that Lemma 1 and Proposition 1 continue to hold under this generalization (see the appendix for proofs). Such results warrant a similar efficient algorithm for solving the model with sequential product introductions.

Define Ĥₜ:=Mₜ−Yₜ₋₁.
Algorithm 2.
   ii) First, solve the period T problem. Since G_{T+1}*=0, solve r_{T}(θ_{T}*)=0 to obtain θ_{T}* and then let

$${P}_{iT}^{*} = {c}_{iT} + \frac{1}{{b}_{t}} + {θ}_{T}^{*} .$$

(ii) Next, for t=T−1, T−2, . . . , 1, discretize the plausible range for Hₜ, e.g., [0,1], to N_{H} grid points For each Hₜ value, solve the single-variable equation

rₜ(θₜ)=ĝₜ+1(\acute{H}ₜ,θₜ)
via bisection search to obtain θₜ*(\dot{H}ₜ).
(iii) Finally, identify the path of optimal price and sales from the initial value \dot{H}ₜ=M_{θ}−Yₐ for t=1, 2, . . . , T−1 according to

$${θ}_{t}^{*} = {θ}_{t}^{*} ( {\hat{H}}_{t} ) , \\ {p}_{it}^{*} = {θ}_{t}^{*} + {c}_{it} + \frac{1}{{b}_{t}} , \\ {q}_{it}^{*} = \frac{exp ( {a}_{it} - 1 - {b}_{t} {θ}_{t}^{*} - {b}_{t} {c}_{it} )}{1 + {\sum }_{j ∈ {κ}_{t}} exp ( {a}_{jt} - {b}_{t} {θ}_{t}^{*} - {b}_{t} {c}_{jt} )} , \\ {Z}_{it}^{*} = [ α + β ( {M}_{t} - {\hat{H}}_{t} ) ] {\hat{H}}_{t} {q}_{it}^{*} , \\ {\hat{H}}_{t + 1} = Δ {M}_{t + 1} + {\hat{H}}_{t} \{ 1 - [ α + β ( {M}_{t} - {\hat{H}}_{t} ) ] {\sum }_{i ∈ {κ}_{t}} {q}_{it}^{*} \} .$$

In addition, it can be verified that Corollaries 4 and 5 continue to hold. Suppose the remaining market potential Hₜ monotonically decreases with time, then Corollaries 1 and 2 hold in the sequential model. However, this may not always be the case if Mₜ varies with time; for example, Mₜ could increase due to the introduction of a new product, which may cause a temporary increase in Hₜ and consequently a price kink. Nonetheless, the relationship in Lemma 1 still helps identify the overall price trend with such potential kinks.

Therefore, the model framework and the solution approach discussed herein are flexible for studying sequential product introductions and the impact of the pricing decisions in this context, and address stochastic demand and product-specific imitation effect, respectively. The present method accommodates multiple product introductions without creating prohibitive computation burdens. It applies to scenarios in which products of the same generation are introduced sequentially (for example, when the paperback version of a book is introduced sometime after the hardcover), as well as scenarios in which products of different generations are introduced sequentially (for example, some applications of other models are for overlapping generations of DRAM products).

### Stochastic Demand

In some embodiments, the present pricing model described herein models the expected demand using diffusion-choice models. It is possible to extend this to stochastic demand, as we illustrate in this section. The crucial results continue to hold, and the stochastic model can be useful for dynamically pricing the products based on the realized adoption.

Let Y be the level of cumulative adoption, and M−Y be the remaining market potential. The diffusion intensity is given by \check{α}+\check{β}Y where \check{α}: parameterize the innovation effect while \check{β} parameterizes the imitation effect. Let (M−Y)(\check{α}+\check{β}Y) be the probability that there is a customer arrival. We choose the time unit sufficiently small that there can be at most one arrival in each period. For a given customer arrival, the customer chooses among n products (and the no-purchase option) with the choice probability given in equation (3). If the customer purchases a product, then the cumulative adoption increases by one unit. Define Jₜ as the profit-to-go from period t onward. The firm maximizes the total profit over the planning horizon of T time periods by solving the following dynamic programming problem:

$${J}_{t} ( Y , {q}_{t} ) = ( M - Y ) ( \breve{α} + \breve{β} Y ) {\sum }_{i = 1}^{n} {q}_{it} ( {p}_{it} ( {q}_{t} ) - {c}_{it} + {J}_{t + 1}^{*} ( Y + 1 ) ) + [ 1 - ( M - Y ) ( \breve{α} + \breve{β} Y ) + ( M - Y ) ( \breve{α} + \breve{β} Y ) {q}_{0 t} ] {J}_{t + 1}^{*} ( Y ) \\ where {J}_{t}^{*} ( Y ) := {max}_{{q}_{t}} {J}_{t} ( Y , {q}_{t} ) , t = 1 , … , T , {J}_{T + 1}^{*} ( Y ) = 0. \qquad ( 33 )$$

Note that the adoption level stays at Y in period t+1 if there is no arrival, which occurs with probability 1−(M−Y)(\check{α}+\check{β}Y), or there is an arrival but the customer chooses not to purchase any of the n products, which occurs with probability (M−Y)(α+βY)q₀ₜ. This formulation is consistent with stochastic demand models under MNL choices adopted in the literature (e.g., Dong et al. (2009) for dynamic pricing and inventory control). In our formulation, the arrival rate is endogenous and given by the diffusion equation instead of a constant and exogenous arrival rate.

Taking derivative of Jₜ(Y, qₜ) with respect to qᵢₜ, the following first-order condition (derivation derived in the appendix) is obtained

$${p}_{it} - {c}_{it} - \frac{1}{{b}_{t}} = {\sum }_{{i}^{′} = 1}^{n} \frac{{q}_{{i}^{′} t} / {q}_{0 t}}{{b}_{t}} + {J}_{t + 1}^{*} ( Y ) - {J}_{t + 1}^{*} ( Y + 1 ) . \qquad ( 34 )$$

The right hand side is independent of the index i. Thus at optimality, “equal markup” holds and there exists θₜ such at

$${p}_{it} - {c}_{it} - \frac{1}{{b}_{t}} = {θ}_{t} ∀ i . \qquad ( 35 )$$

We can rewrite the (34) as

$${θ}_{t} = \frac{1}{{b}_{t}} {\sum }_{i} {e}^{{a}_{it} - 1 - {b}_{t} {c}_{it} - {b}_{t} {θ}_{t}} + {J}_{t + 1}^{*} ( Y ) - {J}_{t + 1}^{*} ( Y + 1 ) , \qquad ( 36 )$$

or equivalently,

rₜ(θₜ)=Jₜ₊₁*(Y)−Jₜ₊₁*(Y+1), (37)

where

$${r}_{t} ( {θ}_{t} ) := {θ}_{t} - \frac{1}{{b}_{t}} {\sum }_{i} {e}^{{a}_{it} - 1 - {b}_{t} {c}_{it} - {b}_{t} {θ}_{t}} . \qquad ( 38 )$$

Let θₜ*(Y) be the solution to the first-order condition in (38). We can derive a similar connection between rₜ₋₁(θₜ*(Y)) and rₜ(θₜ*(Y)) as in Lemma 1.

### Lemma 2.

Consider

$${r}_{t - 1} ( {θ}_{t - 1}^{*} ( Y ) ) - {r}_{t} ( {θ}_{t}^{*} ( Y ) ) = ( M - Y ) ( \breve{α} + \breve{β} Y ) {\sum }_{i = 1}^{n} \frac{{e}^{{a}_{it} - {b}_{t} {c}_{it} - 1 - {b}_{t} {θ}_{t}^{*} ( Y )}}{{b}_{t}} - ( M - Y - 1 ) ( \breve{α} + \breve{β} Y + \breve{β} ) {\sum }_{i = 1}^{n} \frac{{e}^{{a}_{it} - {b}_{t} {c}_{it} - 1 - {b}_{t} {θ}_{t}^{*} ( Y + 1 )}}{{b}_{t}} . \qquad ( 39 )$$

This relationship simplifies the dynamic programming problem and also leads to a unique optimal price solution.

Proposition 3. The solution to (38) is unique for any given Y∈[0, M) and t=1, . . . , T.

We rewrite the relationship (40) as

$${r}_{t - 1} ( {θ}_{t - 1}^{*} ( Y ) ) = {θ}_{t}^{*} ( Y ) + [ ( M - Y ) ( \breve{α} + \breve{β} Y ) - 1 ] {\sum }_{i = 1}^{n} \frac{{e}^{{a}_{it} - {b}_{t} {c}_{it} - 1 - {b}_{t} {θ}_{t}^{*} ( Y )}}{{b}_{t}} - ( M - Y - 1 ) ( \breve{α} + \breve{β} Y + \breve{β} ) {\sum }_{i = 1}^{n} \frac{{e}^{{a}_{it} - {b}_{t} {c}_{it} - 1 - {b}_{t} {θ}_{t}^{*} ( Y + 1 )}}{{b}_{t}} . \qquad ( 40 )$$

Hence given θₜ*(Y) for Y=0, . . . , M−1, it is straightforward to compute rₜ₋₁(θₜ₋₁*(Y)); given the mono-tonicity of Tₜ₋₁(·), one can apply bisection search to find θₜ₋₁*(Y). Therefore, using these analytical results, the dynamic program is easily solved with backward computation. Furthermore, we can characterize additional structural properties of the optimal solution with respect to the adoption level Y and the time trend.

Proposition 4. (i)

$$( i ) {θ}_{t}^{*} ( Y + 1 ) \geq {θ}_{t}^{*} ( Y ) for Y = 0 , … , M - 1 and$$

$$t = 1 , … , T . \\ ( ii ) {r}_{t - 1} ( {θ}_{t - 1}^{*} ( Y ) ) \geq {r}_{t} ( {θ}_{t}^{*} ( Y ) ) if Y \geq \frac{M - 1}{2} - \frac{\breve{α}}{2 \breve{β}} , t = 2 , … , T .$$

Corollary 6. Suppose product qualities, costs and price sensitivities are time-invariant, i.e., aᵢₜ=
aᵢ, bₜ=b and cᵢₜ=cᵢ for i=1, . . . , n; t=1, . . . , T. Let pᵢₜ*(Y) be the optimal price of product i at period t when the current adoption level is Y. Then (i) pᵢₜ*(Y+1)≥pᵢₜ*(Y) for Y=0, . . . , M−1 and t=1, . . . , T (ii)

$${p}_{it - 1}^{*} ( Y ) \geq {p}_{it}^{*} ( Y ) if Y \geq \frac{M - 1}{2} - \frac{\breve{α}}{2 \breve{β}} , t = 2 , … , T .$$

This indicates that, all else equal, the optimal price is higher at higher adoption level. In addition, as adoption exceeds a certain level, the optimal prices decrease (weakly) over time.

The stochastic model is solvable with similar technique developed for the main model and examines the perspective of dynamic pricing. However, it does not supersede the main model for two reasons. The main model is based on a family of models that have been proven to work empirically. To our knowledge, diffusion-choice models applied in practice are all deterministic variations of the main model. Rigorous econometrics methods are well established to parameterize such models with statistical rigor, which facilitates the subsequent price optimization with proper input parameters based on sales data. The stochastic model is yet to be tested. Since it is based on a conceptual illustration of infinitesimally small time intervals (such that there can be at most one arrival of a purchase occasion), it remains unclear how to parameterize such a conceptual model with real data. In practice, single-unit demand arrival is not observed in most data set, one may have to use the main model parameter α and β to heuristically estimate parameters \check{α} and \check{β} for the stochastic model. Second, the stochastic model focuses more on the response strategy of dynamic pricing, i.e., how should prices be adjusted at a given time based on the stochastic realization of the adoption level, while the main model allows us to characterize the optimal adoption path along with the optimal price trend a priori, and offers practical guidance for strategic pricing over product life cycles.

### 6.3 Product-Specific Word-of-Mouth Effect

It is possible that the word-of-mouth effect may also be driven by the cumulative adoption of each individual product in addition to the aggregate adoption. For example, a consumer who bought an iPhone with a 256 GB memory may communicate the benefit of a large size memory to non-adopters and thus may positively influence the sales of the 256 GB model. Hence it may be desirable to consider product-specific imitation in diffusion-choice models. In this extension, we examine a more general model in which this product-specific word-of-mouth effect is also considered. In particular, the demand for product i in period t is given by

Zᵢₜ=(M−Yₜ₋₁)(α+βYₜ₋₁+γYᵢₜ₋₁)qᵢₜ (41)

where Yᵢₜ₋₁ is the cumulative sales of product i by the end of period t−1, γ>0 parameterizes the intensity of the product-specific imitation effect, and other terms are as defined in Section 3. As we show next, accounting for the product-specific imitation effect necessitates tracking product-specific diffusion intensity, leading to a much more complex problem. As a result, the reduction of choice probability vector qₜ to a single variable θₜ adopted in Section 4.1 does not carry through. To see this, note that the remaining market potential and the diffusion intensity become

$$\begin{matrix}{H}_{t + 1} = {H}_{t} ( 1 - {\sum }_{j = 1}^{n} {F}_{jt} {q}_{jt} ) & ( 42 ) \\ {F}_{it + 1} = {F}_{it} + {H}_{t} ( β {\sum }_{j = 1}^{n} {F}_{jt} {q}_{jt} + γ {F}_{it} {q}_{it} ) & ( 43 )\end{matrix}$$

and the optimization problem becomes

$${J}_{t} = {max}_{{{q}_{it} ∈ [ 0 , 1 ] ,}_{i = 1 , … , n}} [ {H}_{t} {\sum }_{i = 1}^{n} {F}_{it} ( {p}_{it} ( {q}_{it} ) - {c}_{it} ) {q}_{it} + {J}_{t + 1} ] ,$$

where J_{T+1}=0. Denote the vector of product-specific diffusion intensity with Fₜ=(F₁ₜ, F₂ₜ, . . . , Fₙₜ). Define

$${\breve{G}}_{t} ( {F}_{t} , {q}_{t} ) := {\sum }_{i = 1} ( {p}_{it} ( {q}_{t} ) - {c}_{it} ) {q}_{it} {F}_{it} + ( 1 - {\sum }_{i = 1}^{n} {F}_{it} {q}_{it} ) {\breve{G}}_{t + 1}^{*} ( {F}_{t + 1} ( {F}_{t} , {q}_{t} ) )$$

$$where {\breve{G}}_{t}^{*} ( {F}_{t} ) = {max}_{{q}_{it} ∈ [ 0 , 1 ] , i = 1 , … , n} {\breve{G}}_{t} ( {F}_{t} , {q}_{t} ) .$$

We note that the interpretation of \check{ }G(·) differs from that of G(·) in Section 4 due to the term Fit. The first-order condition of optimality is given by (derivation provided in the appendix):

$${p}_{it} ( {q}_{t} ) - {c}_{it} - \frac{1}{{b}_{t}} = {\sum }_{{i}^{′} = 1}^{n} \frac{{q}_{{i}^{′} t}}{{b}_{t} ( 1 - {\sum }_{j = 1}^{n} {q}_{jt} )} \cdot \frac{{F}_{{i}^{′} t}}{{F}_{it}} + {\breve{G}}_{t + 1}^{*} - {H}_{t + 1} ( γ \frac{\partial {\breve{G}}_{t + 1}^{*}}{\partial {F}_{it + 1}} + β {\sum }_{i} \frac{\partial {\breve{G}}_{t + 1}^{*}}{\partial {F}_{{i}^{′} t + 1}} ) . \qquad ( 44 )$$

Contrasting this with equation (15), we observe that the right hand side is dependent on the index i through the term

$$γ \frac{\partial {G}_{t + 1}^{*}}{\partial {F}_{it + 1}} .$$

Hence the “equal mark-up” property no longer holds with product-specific imitation. As a result, the transformation given in equation (16)-(17) is no longer viable. However, despite the added complexity of product-specific imitation, we can reduce the longitudinal complexity employing a similar technique as in Section 4. Define:

$${R}_{it} ( {p}_{t} ) := {p}_{it} - {c}_{it} - \frac{1}{{b}_{t}} - {\sum }_{{i}^{′} = 1}^{n} \frac{{e}^{{a}_{{i}^{′} t} - {b}_{t} {p}_{{i}^{′} t}}}{{b}_{t}} \frac{{F}_{{i}^{′} t}}{{F}_{it}} .$$

We can rewrite the first-order condition as

$${R}_{it} = {\breve{G}}_{t + 1}^{*} - {H}_{t + 1} ( γ \frac{\partial {G}_{t + 1}^{*}}{\partial {F}_{it + 1}} + β {\sum }_{{i}^{′}} \frac{\partial {G}_{t + 1}^{*}}{\partial {F}_{{i}^{′} t + 1}} ) . \qquad ( 45 )$$

Proposition 5. The optimal price pₜ*, t=1, . . . , T satisfies

$$\begin{matrix}{R}_{it - 1} ( {p}_{t - 1}^{*} ) - {R}_{it} ( {p}_{t}^{*} ) = {\sum }_{{i}^{′} = 1}^{n} ( \frac{1}{{b}_{t}} + {\sum }_{j = 1}^{n} \frac{{e}^{{a}_{jt} - {b}_{t} {p}_{jt}^{*}}}{{b}_{t}} \cdot \frac{{F}_{jt}}{{F}_{{i}^{′} t}} ) {q}_{{i}^{′} t} ( {p}_{t}^{*} ) ( {F}_{{i}^{′} t} - β {H}_{t} ) - γ {H}_{t} ( \frac{1}{{b}_{t}} + {\sum }_{j = 1}^{n} \frac{{e}^{{a}_{jt} - {b}_{t} {p}_{jt}^{*}}}{{b}_{t}} \cdot \frac{{F}_{jt}}{{F}_{it}} ) {q}_{it} ( {p}_{t}^{*} ) & ( 46 ) \\ ∀ i = 1 , … , n . & \end{matrix}$$

Proposition 5 connects the optimal price vectors of two adjacent time periods, consequently enabling reduction of the longitudinal complexity. The relationship in Proposition 5 decouples the price decision in each period from all future periods except the immediate next one. Proceeding backward in time, one can solve a system of n equations in each period to obtain the optimal solution path. Although still a problem of substantial size (particularly when the number of products is large), the complexity in the time dimension is significantly reduced.

The time trend of the optimal prices is not as clear-cut as in the case without product-specific imitation, but some general character persists such as indicated in the following corollary.

Corollary 7. There exist
There exist t, t̅∈{1, . . . , T} such that Rᵢₜ₋₁(pₜ₋₁*)≤Rᵢₜ(pₜ*) for t≤t and Rᵢₜ₋₁(pₜ₋₁*)≥Rᵢₜ(pₜ*) for t≥t̅.

### Constrained Pricing Frequency

Next, one practical issue will now be discussed that arises when applying the model and method introduced in this paper. The present model is a discrete-time model, which allows a firm to optimally adjust its product prices at the same frequency as the demand model. That is, if demand forecast is generated using the model given in (2) on a daily, weekly, monthly, or quarterly basis, then the firm is able to optimize prices at the same frequency. However, a firm may choose to or is constrained to adjust price at a lesser frequency; in this case, we describe a heuristic implementation of our method. Suppose that the demand forecast is generated for each unit time period and the firm adjusts price every k time periods. Then let \hat{α}=kα and \hat{β}=kβ and redefine the time unit as k units of the original time unit; in the case of time-varying price sensitivity and cost, use the k-period average of these values. Solve the optimal prices under the demand model with the revised time unit and apply the solution as heuristic prices.

Let

$$Π ( p ) = {\sum }_{t = 1}^{T} {\sum }_{i = 1}^{n} ( {p}_{it} - {c}_{it} ) {Z}_{it} ( p )$$

be the total profit for any given price vector p={pᵢₜ, i=1, . . . , n; t=1, . . . , T}. Let p* be the optimal prices under the single-period pricing frequency, p^{k} be the optimal prices under the
k-period pricing frequency (note that p*=p¹), and \hat{p} be the heuristic prices. It is easy to see that

II(\hat{p})≤II(p^{k})≤II(p*)
and thus II(p*) can be used to bound the performance of the heuristic price p. The percentage profit loss for the heuristic prices is bounded by

$$\frac{Π ( {p}^{*} ) - Π ( \hat{p} )}{Π ( \hat{p} )} .$$

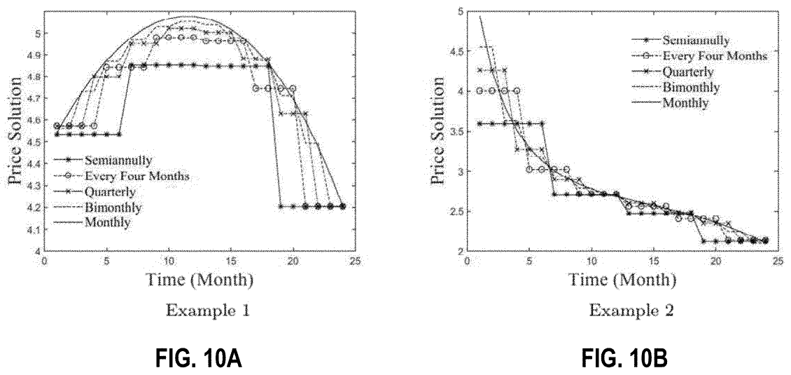

Consider practical examples in which a firm forecasts demand with monthly time buckets but adjusts price less frequently than every month. FIG. 10 illustrates the performance of heuristic price solutions in two examples with monthly demand forecast and a 24-month planning horizon. Optimal monthly prices are computed and the optimal profit is used as a benchmark upper bound for measuring performance of heuristic implementations for which price change occurs bimonthly (i.e., every two months), quarterly, every four months, or semiannually. The parameters of Example 1 in FIGS. 10A and 10B are same as those in FIGS. 6A-8C while we let T=24 for the ease of adjusting pricing frequency. In Example 2, both price sensitivity and cost vary with time, in particular, we let bit be as given in FIG. 4A with λb=0.2 and bᵢₜ be as given in FIG. 5A with λc=0.2 (other parameters are the same as in FIGS. 6A-8C). Note that the prices are computed based on the demand model under the redefined time unit and performance is measured by applying the heuristic prices in the original demand model and comparing the profit with that under the optimal monthly prices. Table I indicates that the performance of heuristic implementation decreases with the pricing interval and that the case of time-varying price sensitivity and cost (Example 2) experiences higher performance loss; however, overall the performance loss is relatively small (less than 3% for six-month pricing interval). In addition, the profit is compared to that obtained under the myopic price solution, i.e., the price vector that maximizes current period profit only (denoted by p^{m}), and shows improvement.

TABLE 1
Performance of Heuristic Implementation.

| | Pricing Interval (months) | 1 | 2 | 3 | 4 | 6 |
|---|---|---|---|---|---|---|
| Example 1 | Profit under Our Solution II(\hat{p}) | 4.2256 | 4.2237 | 4.2197 | 4.2129 | 4.1848 |
| | Bound on Performance | 0% | 0.044% | 0.138% | 0.301% | 0.973% |
| | Loss (II(p*) − II(\hat{p}))/II(\hat{p}) | | | | | |
| − | Profit under Myopic Solution II(p^{m}) | 3.9452 | 3.9452 | 3.9452 | 3.9452 | 3.9452 |
| | Improvement over Myopic | 7.11% | 7.06% | 6.96% | 6.79% | 6.07% |
| | (II(\hat{p}) − II(p^{m}))/II(p^{m}) | | | | | |
| Example 2 | Profit under Our Solution | 2.0696 | 2.0638 | 2.0566 | 2.0454 | 2.0130 |
| | Bound on Performance Loss | 0% | 0.284% | 0.635% | 1.184% | 2.813% |
| | Profit under Myopic Solution | 1.9568 | 1.9512 | 1.9468 | 1.9466 | 1.9307 |
| | Improvement over Myopic | 5.76% | 5.77% | 5.64% | 5.08% | 4.26% |

Embodiments of the model described herein involve two considerations. First, in some embodiments, the model is a discrete-time model, which allows a firm to optimally adjust its product prices at the same frequency as the demand model. If a firm may choose to or is constrained to adjust price at a lesser frequency, the model can be adapted to such practical considerations with sound performance. Second, there may be practical scenarios in which firms are constrained to non-increasing prices even though it might not be optimal. In this case, solving the period t problem requires not only the remaining market potential, but also the last-period prices of each product. As a result, the current method becomes less tractable. However, insights afforded by our model shed light on how this may affect the price solution. In the absence of imitation, we have shown analytically that the optimal price trend is monotonically decreasing when other parameters are time invariant (Corollary 3). The imitation effect may cause an initial upward price trend because lower price early in the diffusion speeds up the word-of-mouth effect, benefiting the firm. If the firm is constrained to non-increasing prices, then it may not be able to set lower prices early in the diffusion cycle to take full advantage of the word-of-mouth effect; this will consequently slow down the diffusion and drive the firm to apply lower prices later in the diffusion (relative to the unconstrained price path).

### Computing Device

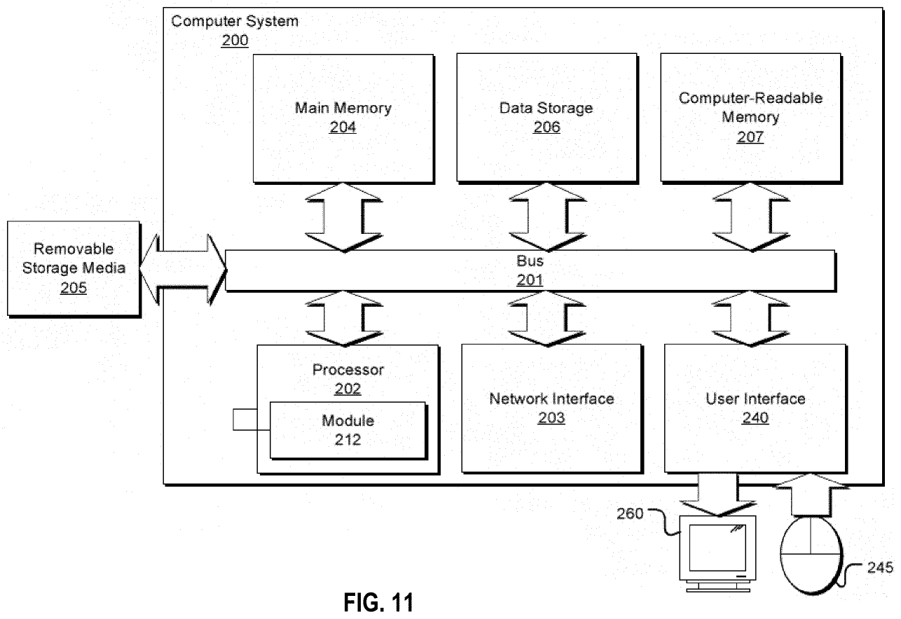

FIG. 11 illustrates an example of a suitable computing device 200 which may be used to implement various aspects of an optimizing pricing model and one or more corresponding solution algorithms described herein. More particularly, in some embodiments, aspects of the optimizing pricing model may be translated to software or machine-level code, which may be installed to and/or executed by the computing device 200 such that the computing device 200 is configured to generate optimized pricing under diffusion-choice models according to the methods and functions described herein. It is contemplated that the computing device 200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 200 may include various hardware components, such as a processor 202, a main memory 204 (e.g., a system memory), and a system bus 201 that couples various components of the computing device 200 to the processor 202. The system bus 201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 200 may further include a variety of memory devices and computer-readable media 207 that includes removable/non-removable media and volatile/nonvolatile media and/or tangible media, but excludes transitory propagated signals. Computer-readable media 207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the general purpose computing device. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 204 includes computer storage media in the form of volatile/nonvolatile memory such as read only memory (ROM) and random access memory (RAM). A basic input/output system (BIOS), containing the basic routines that help to transfer information between elements within the general purpose computing device (e.g., during start-up) is typically stored in ROM. RAM typically contains data and/or program modules that are immediately accessible to and/or presently being operated on by processor 202. Further, data storage 206 stores an operating system, application programs, and other program modules and program data.

The data storage 206 may also include other removable/non-removable, volatile/nonvolatile computer storage media. For example, data storage 206 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules and other data for the general purpose computing device 200.

A user may enter commands and information through a user interface 240 (displayed via a monitor 260) by engaging input devices 245 such as a tablet, electronic digitizer, a microphone, keyboard, and/or pointing device, commonly referred to as mouse, trackball or touch pad. Other input devices 245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 245 are in operative connection with the processor 202 and may be coupled to the system bus 201, but may be connected by other interface and bus structures, such as a parallel port, game port or a universal serial bus (USB). A monitor 260 or other type of display device is also connected to the system bus 201. The monitor 260 may also be integrated with a touch-screen panel or the like.

The computing device 200 may be implemented in a networked or cloud-computing environment using logical connections of a network interface 203 to one or more remote devices, such as a remote computer. The remote computer may be a personal computer, a server, a router, a network PC, a peer device or other common network node, and typically includes many or all of the elements described above relative to the general purpose computing device. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 200 may be connected to a public and/or private network through the network interface 203. In such embodiments, a modem or other means for establishing communications over the network is connected to the system bus 201 via the network interface 203 or other appropriate mechanism. A wireless networking component including an interface and antenna may be coupled through a suitable device such as an access point or peer computer to a network. In a networked environment, program modules depicted relative to the general purpose computing device, or portions thereof, may be stored in the remote memory storage device.

### Computing System

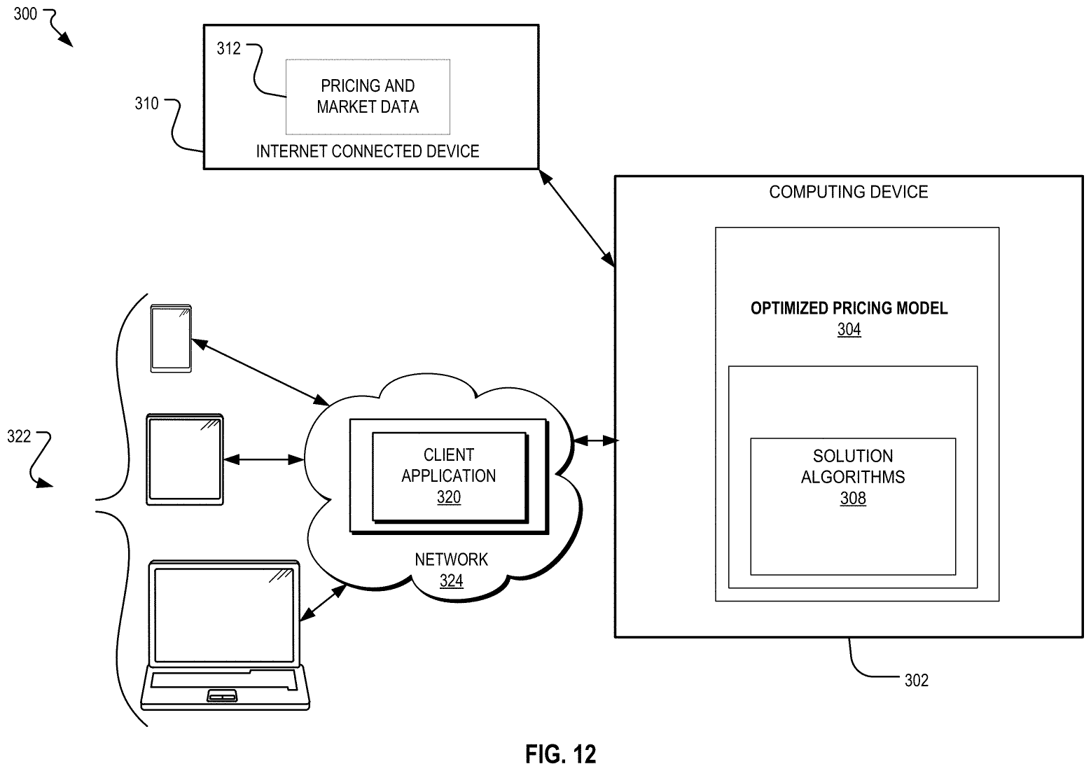

Referring to FIG. 12, in some embodiments a computer-implemented framework for optimized pricing under diffusion-choice models described herein may be implemented at least in part by way of a computing system 300. In general, the computing system 300 may include a plurality of components, and may include at least one computing device 302, which may be equipped with at least one or more of the features of the computing device 200 described herein. As indicated, the computing device 302 may be configured to implement an optimized pricing model 304 which may include one or more of a solution algorithm 306 for generating optimized pricing as described herein. Aspects of the optimized pricing model 304 may be implemented as code and/or machine-executable instructions executable by the computing device 302 that may represent one or more of a procedure, a function, a subprogram, a program, a routine, a subroutine, a module, a software package, a class, or any combination of instructions, data structures, or program statements related to the above MTTP model training methods. A code segment of the optimized pricing model 304 may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In other words, aspects of the optimized pricing model 304 may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium, and a processor(s) associated with the computing device 302 may perform the tasks defined by the code; such that the computing device 302 is configured via the aforementioned hardware and software components to perform the optimized price functionality described herein.

As further shown, the system 300 may include at least one internet connected device 310 in operable communication with the computing device 302. In some embodiments, the internet connected device 310 may provide pricing and market data 312 to the computing device 302 for training purposes or real world pricing optimization. The internet connected device 310 may include any electronic device capable of accessing/tracking pricing and market data such over a predetermined period of time. In addition, the system 300 may include a client application 320 which may be configured to provide aspects of the optimized pricing model 304 to any number of client devices 322 via a network 324, such as the Internet, a local area network, a wide area network, a cloud environment, and the like.

Example embodiments described herein may be implemented at least in part in electronic circuitry; in computer hardware executing firmware and/or software instructions; and/or in combinations thereof. Example embodiments also may be implemented using a computer program product (e.g., a computer program tangibly or non-transitorily embodied in a machine-readable medium and including instructions for execution by, or to control the operation of, a data processing apparatus, such as, for example, one or more programmable processors or computers). A computer program may be written in any form of programming language, including compiled or interpreted languages, and may be deployed in any form, including as a stand-alone program or as a subroutine or other unit suitable for use in a computing environment. Also, a computer program can be deployed to be executed on one computer, or to be executed on multiple computers at one site or distributed across multiple sites and interconnected by a communication network.

Certain embodiments may be described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

It should be understood from the foregoing that, while particular embodiments have been illustrated and described, various modifications can be made thereto without departing from the spirit and scope of the present disclosure as will be apparent to those skilled in the art. Such changes and modifications are within the scope and teachings of this disclosure as defined in the claims appended hereto.

What is claimed is:

1. A method of improving computer-implemented price optimization, comprising:
providing a processor in communication with a tangible storage medium storing instructions that are executed by the processor to perform operations comprising:
defining a market having at least a product and a pool of potential customers;
generating a value of cumulative sales of the product by summing a number of discreet sales of the product in a predetermined period;
generating a value of utility of acquiring the product in the predetermined period at a price;
employing a multinomial logit choice model to generate a value of purchase probability for one of the pool of potential customers purchasing the product within the predetermined period; and
optimizing the price of the product by solving a price optimization problem which takes as input at least the price, the number of discreet sales, and a value of cost of the product during the predetermined period.

2. The method of claim 1, further comprising defining a unimodal price path for a value of time-invariant product quality, the value of cost of the product during the predetermined period, and a value of price sensitivity of the product.

3. The method of claim 2, wherein the value of time-invariant product quality is a measure of attractiveness of the product based on a set of non-price attributes and features.

4. The method of claim 1, wherein the multinomial logit choice model generates an adoption decision based on the value of purchase probability.

5. The method of claim 1, wherein a sale occurs when, sequentially, a purchase occasion for one of the pool of potential customers occurs and the one of the pool of potential customers chooses the product from among a set of available products.

6. The method of claim 1, wherein a value of number of customers facing a purchase decision within the predetermined period is dependent upon a size of a remaining market potential and upon a fractional rate representing a ratio of customers in the remaining market potential who will face a purchase occasion.

7. The method of claim 1, wherein the price optimization problem is a summation of the number of discreet sales of the product multiplied by the difference between the price of the product during the predetermined period and cost of the product during the predetermined period.
